(19) United States
(12) Patent Application Publication
(10) Pub. No.: US 2026/0197411 A1
(43) Pub. Date: Jul. 9, 2026

(54) IMAGE READING DEVICE

(71) Applicant: SEIKO EPSON CORPORATION, Tokyo (JP)

(72) Inventors: Noriyuki KOYANAGI, KITAKYUSHU-SHI (JP); Makoto WADA, KITAKYUSHU-SHI (JP); Ippo HASHIMOTO, SHIMOSUWA-MACHI (JP)

(21) Appl. No.: 19/440,878

(22) Filed: Jan. 6, 2026

(30) Foreign Application Priority Data
Jan. 9, 2025 (JP) 2025-003233

(51) Int. Cl. H04N 1/00; B42D 9/04

(52) U.S. Cl. CPC H04N 1/00809; B42D 9/04; H04N 1/00665

(57) ABSTRACT

An image reading device 1 includes a transport section 20 that transports, along a transport path R, a medium B in which plural sheets S are bound together; a sheet turning section 30 that is provided on the transport path R and that turns the sheets S of the medium B being transported; and a reading section 50 that is provided on the transport path R and downstream of the sheet turning section 30 in a transport direction, and that reads the sheets S.

The present application is based on, and claims priority from JP Application Serial Number 2025-003233, filed January 9, 2025, the disclosure of which is hereby incorporated by reference herein in its entirety.

### BACKGROUND

### Technical Field

The present disclosure relates to an image reading device.

### Related Art

In the related art, there has been known a device having a function of turning a page of a booklet. For example, JP-A-2009-137013 proposes a bankbook page turning device corresponding to a bankbook as a booklet.

However, the page turning device disclosed in JP-A-2009-137013 has a problem that it is difficult to improve the convenience of a user because the page turning device does not have an image reading function.

### SUMMARY

An image reading device includes a transport section that transports, along a transport path, a medium in which plural sheets are bound together; a sheet turning section that is provided on the transport path and that turns the sheets of the medium being transported; and a reading section that is provided on the transport path and downstream of the sheet turning section in a transport direction, and that reads the sheets.

### BRIEF DESCRIPTION OF THE DRAWINGS

FIG. 1 is a perspective view illustrating an appearance of an image reading device according to an embodiment.

FIG. 2 is a cross-sectional view illustrating a configuration of the image reading device.

FIG. 3 is a perspective view illustrating an arrangement of a sheet turning section and an adjustment unit.

FIG. 4 is a side view illustrating a configuration of the adjustment unit.

FIG. 5 is a flowchart illustrating a reading method.

FIG. 6 is a schematic diagram illustrating a skew correction process.

FIG. 7 is a schematic diagram illustrating a skew correction process.

FIG. 8 is a schematic diagram illustrating a reading method.

FIG. 9 is a schematic diagram illustrating the reading method.

FIG. 10 is a schematic diagram illustrating the reading method.

FIG. 11 is a schematic diagram illustrating the reading method.

FIG. 12 is a schematic diagram illustrating the reading method.

FIG. 13 is a schematic diagram illustrating the reading method.

FIG. 14 is a schematic diagram illustrating the reading method.

FIG. 15 is a schematic diagram illustrating the reading method.

FIG. 16 is a schematic diagram illustrating the reading method.

FIG. 17 is a schematic diagram illustrating the reading method.

FIG. 18 is a schematic diagram illustrating the reading method.

### DESCRIPTION OF EMBODIMENTS

In embodiments described below, an image reading device that reads a bankbook, a passport, or the like as a medium will be described as an example with reference to the drawings. A medium applied to the image reading device of the present disclosure is not limited to the above.

In the following drawings, XYZ axes which are coordinate axes orthogonal to each other are given, a direction indicated by each arrow is a + direction, and a direction opposite to the + direction is a - direction. In the present embodiment, a state in which the image reading device is installed on a horizontal plane will be described. In the above-described state, a -Z direction coincides with a vertical direction. A +Z direction may be referred to as an upward direction, and the -Z direction may be referred to as a downward direction. In the following drawings, the size of each member is different from the actual size for convenience of illustration.

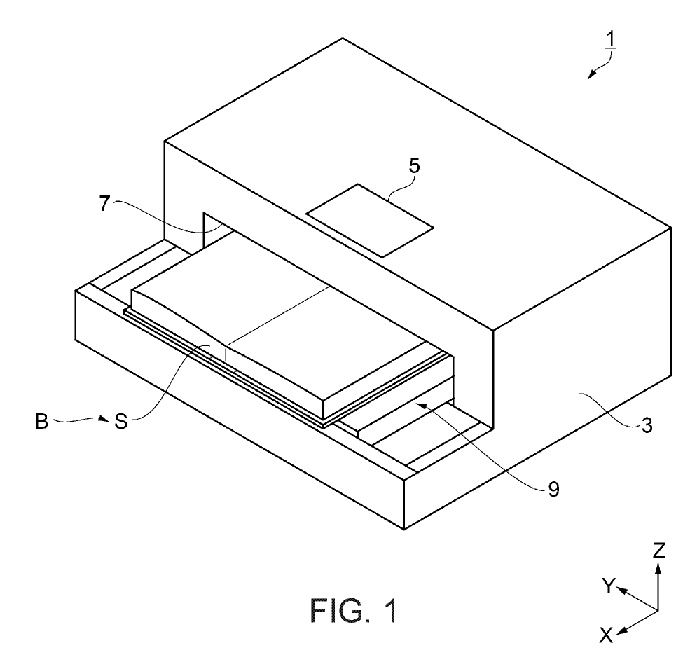

As illustrated in FIG. 1, an image reading device 1 according to the present embodiment includes a housing 3, an operation panel 5, a feed port 7, and a placement section 9. The image reading device 1 is a fully automatic scanner that automatically turns and reads a sheet S of a medium B.

The medium B is a booklet in which a plurality of the sheets S are bound together by a method such as saddle stitching or perfect binding. Although not illustrated, an image such as a character, a number, a photograph, and a picture to be read by the image reading device 1 is formed on each sheet S. The dimension of the medium B along a Y-axis is not particularly limited, but for example, the maximum dimension is approximately 300 mm, which is approximately equal to a long side of an A4 size sheet.

The housing 3 accommodates various configurations related to reading of an image and turning of the sheet S. The housing 3 is rectangular when viewed from above. The housing 3 includes a substantially rectangular parallelepiped main body and the placement section 9 protruding from a lower side of a surface of the main body facing a +X direction. The housing 3 is formed of, for example, resin, metal, or the like.

The image reading device 1 may be used while being placed on a table such as a desk. A user of the image reading device 1 basically operates the image reading device 1 from the +X direction. In the following description, a user of the image reading device 1 is also simply referred to as a user.

The operation panel 5 displays various types of information to a user and receives various operations and various settings input by the user. The operation panel 5 is electrically connected to a control section (to be described later). The control section controls the image reading device 1 also based on information input to the operation panel 5.

The operation panel 5 is provided on a surface of the housing 3 facing upward. Specifically, the operation panel 5 is provided on a main surface of the housing 3 facing upward, at a center of a side in the +X direction in a direction along the Y-axis. The operation panel 5 is, for example, a touch panel type liquid crystal display. The operation panel 5 may include a physical button in addition to the liquid crystal display.

The feed port 7 is an opening provided in the housing 3 and penetrating the inside and outside of the image reading device 1. The medium B is fed into the housing 3 from the feed port 7, returned in the +X direction after an image is read in the housing 3, and discharged to the outside of the housing 3 from the feed port 7. Since the feed port 7 also serves as a discharge port, a user may set the medium B in the feed port 7, and then pick up the medium B coming out of the feed port 7 after waiting for the completion of a reading process. For example, the convenience of a user is further improved compared to a form in which the medium B is discharged from a rear surface side of the feed port 7.

The feed port 7 is provided above the placement section 9 on a surface of the housing 3 facing the +X direction. The feed port 7 has a substantially rectangular shape when viewed from the +X direction, and a longitudinal direction thereof is along the Y-axis. The dimension of the feed port 7 is set as appropriate in accordance with the dimension of the medium B.

The medium B to be introduced into the image reading device 1 is placed on the placement section 9. A user opens the medium B, places the medium B on the placement section 9, and inserts an end section of the medium B in a -X direction into the feed port 7. At this time, the user places a front cover and a back cover face down, and aligns the boundary between adjacent sheets S along the Y-axis. In particular, regardless of whether the medium B is right-opening or left-opening, the sheet S having a smaller page number among the adjacent sheets S is set to the -X direction on a leading side. The placement section 9 may be provided with a guide member or the like that defines a position of the medium B in a direction along the Y-axis.

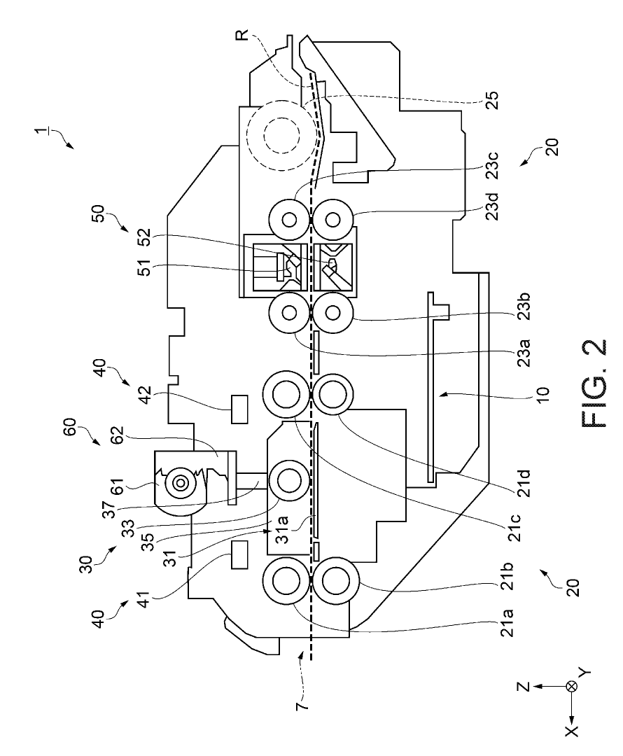

As illustrated in FIG. 2, the image reading device 1 includes a control section 10, a transport section 20, a sheet turning section 30, a detection section 40, a reading section 50, and an adjustment unit 60. FIG. 2 illustrates an internal configuration of the image reading device 1 excluding the housing 3. In the following description of FIG. 2, a state viewed from a -Y direction will be described unless otherwise specified.

In FIG. 2, a transport path R of the medium B is indicated by a broken line. The transport path R is located in the middle of the image reading device 1 in an up-down direction, extends from the feed port 7 in the -X direction, and is arranged up to the vicinity of a rear roller 25 in the -X direction. The medium B is transported along an XY plane in the transport path R. The transport path R includes a forward path from the feed port 7 toward the vicinity of the rear roller 25 and a return path from the vicinity toward the feed port 7. The transport path R is switched between the forward path and the return path at a turning point at an end section in the -X direction.

A direction in which the medium B is transported in the transport path R is referred to as a transport direction. In the present specification, a transport direction of the forward path is set as the -X direction, and a transport direction of the return path is set as the +X direction. However, in an overlap correction process or the like (to be described later), the medium B may be moved in a direction opposite to the transport direction.

The transport section 20 transports the medium B along the transport path R. The transport section 20 includes transport rollers 21a, 21b, 21c, and 21d corresponding to the sheet turning section 30, transport rollers 23a, 23b, 23c, and 23d corresponding to the reading section 50, and the rear roller 25.

The sheet turning section 30 includes a sheet turning roller 33 and a support section 31. The reading section 50 includes an upper unit 51 and a lower unit 52.

In the image reading device 1, the transport rollers 21a and 21b, the sheet turning roller 33 and the support section 31, the transport rollers 21c and 21d, the transport rollers 23a and 23b, the upper unit 51 and the lower unit 52, the transport rollers 23c and 23d, and the rear roller 25 are arranged in this order from the feed port 7 toward the turning point along the transport path R.

The control section 10 is electrically connected to each component of the image reading device 1, and integrally controls various operations of the image reading device 1. The control section 10 is arranged below the transport path R.

The control section 10 is electrically connected to a cloud network, an information terminal such as a personal computer, and a storage device such as a universal serial bus (USB) memory via a wireless local area network (LAN), a connection terminal arranged in the housing 3, or the like. Image information of the medium B read by the image reading device 1 can be transmitted to and stored in the information terminal, the storage device, or the like. The image reading device 1 may be operated not only from the operation panel 5 described above but also from the information terminal.

The control section 10 includes hardware such as a central processing unit (CPU), a read only memory (ROM), and a random access memory (RAM). The control section 10 controls the image reading device 1 by executing a predetermined control program using a CPU. The ROM is a nonvolatile storage device and stores a control program executed by the CPU and data processed by the control program. The RAM constitutes a work area of the CPU. The CPU loads a control program read from the ROM or the like into the RAM, and executes the loaded control program to control the image reading device 1.

The control section 10 may have a function of analyzing image information, a function of collating an analysis result of the image information with information other than the image information, and the like.

The transport rollers 21a and 21b pull in the medium B inserted into the feed port 7 and transport the medium B to the support section 31, and discharge the medium B, on which reading is completed, from the feed port 7. The transport rollers 21c and 21d transport the medium B in the -X direction or the +X direction.

The transport rollers 21a, 21b, 21c, and 21d are substantially cylindrical rotation members, and a shaft section (not illustrated) penetrates the center of each of the transport rollers 21a, 21b, 21c, and 21d. Each shaft section is a substantially rod-shaped member and is arranged along the Y-axis.

Two of each of the transport rollers 21a, 21b, 21c, and 21d are provided in a direction along the Y-axis. The number of each of the transport rollers 21a, 21b, 21c, and 21d is not limited to two, and may be one or three or more.

The transport rollers 21a and 21b are paired in the up-down direction, and the transport rollers 21c and 21d are also paired in the up-down direction. The transport rollers 21a and 21b are arranged in the +X direction with respect to the support section 31, and the transport rollers 21c and 21d are arranged in the -X direction. The transport rollers 21a and 21c are arranged above the transport path R, and the transport rollers 21b and 21d are arranged below the transport path R. The transport rollers 21a, 21b, 21c, and 21d are formed of elastic materials such as rubber.

The transport rollers 21a, 21b, 21c, and 21d are driven by a first drive section (not illustrated) via the corresponding shaft sections and rotate about central axes along the Y-axis. The medium B is transported while being sandwiched between the transport roller 21a and the transport roller 21b and between the transport roller 21c and the transport roller 21d. When the medium B is transported in the -X direction, the transport rollers 21a and 21c rotate counterclockwise, and the transport rollers 21b and 21d rotate clockwise. When the medium B is transported in the +X direction, the transport rollers 21a, 21b, 21c, and 21d rotate in directions opposite to those described above. The first drive section is, for example, an electric motor. The first drive section changes the rotation and stop, the rotation direction, the rotation speed, and the rotation time of the transport rollers 21a, 21b, 21c, and 21d under the control of the control section 10.

The transport roller 21a is supported by a support member (not illustrated) via the corresponding shaft section, is biased downward, and is displaced in the up-down direction. The distance between the transport roller 21a and the transport roller 21b is adjusted depending on the thickness of the medium B in the up-down direction. By this, the distance is adjusted depending on the thickness of the medium B, and the medium B is securely sandwiched between the transport rollers 21a and 21b.

The transport roller 21c is also supported by a support member (not illustrated) via the corresponding shaft section, is biased downward, and is displaced in the up-down direction. The distance between the transport roller 21c and the transport roller 21d is adjusted depending on the thickness of the medium B in the up-down direction. By this, the distance is adjusted depending on the thickness of the medium B, and the medium B is securely sandwiched between the transport rollers 21c and 21d.

The sheet turning section 30 is provided on the transport path R and turns the sheet S of the medium B being transported. The sheet turning section 30 includes a holding member 35 and a biasing section 37 in addition to the sheet turning roller 33 and the support section 31 described above.

The support section 31 includes a support surface 31a that supports the medium B. The support surface 31a is a platen for performing a sheet turning process (to be described later), faces upward, and is along the XY plane. The support surface 31a is arranged below the transport path R. The support section 31 supports the medium B being transported from below on the support surface 31a.

A skew detection section (not illustrated) is provided at a position sandwiching the transport path R in the up-down direction with respect to the support surface 31a. Although details will be described later, the skew detection section detects skew of the medium B with respect to an X-axis.

The sheet turning roller 33 sandwiches the medium B between the sheet turning roller 33 and the support surface 31a and turns the uppermost sheet S of a plurality of the sheets S of the medium B. The sheet turning roller 33 is arranged above the transport path R and faces the support surface 31a of the support section 31 in the up-down direction. The sheet turning roller 33 is formed of, for example, an elastic material such as rubber.

The distances between the sheet turning roller 33 and the support surface 31a of the support section 31 are changed depending on the thickness of the medium B. Specifically, the support surface 31a of the support section 31 is fixed to a structural member of the image reading device 1, whereas the sheet turning roller 33 is displaceable in the up-down direction. Even if the thickness of the medium B changes, the medium B can be securely held between the support surface 31a and the sheet turning roller 33, and the sheet S can be turned.

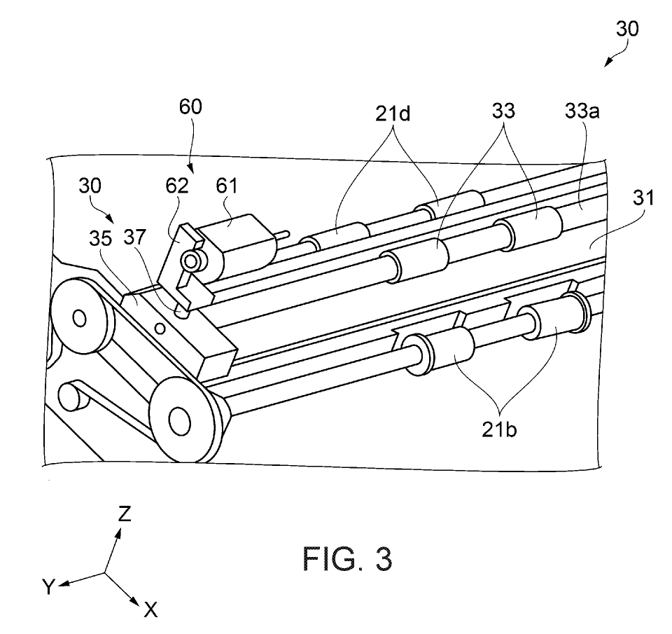

As illustrated in FIG. 3, two sheet turning rollers 33 are provided in a direction along the Y-axis. The number of the sheet turning rollers 33 is not limited to two, and may be one or three or more.

Each of the sheet turning rollers 33 is a substantially cylindrical rotation member. A shaft section 33a penetrates through the center of the sheet turning roller 33. The shaft section 33a is a substantially rod-shaped member and is arranged along the Y-axis. The sheet turning roller 33 is rotatably supported by the holding member 35 via the shaft section 33a. In FIG. 3, only the holding member 35 at an end section in a +Y direction with respect to the shaft section 33a is illustrated, but the holding member 35 is also provided at an end section in the -Y direction.

The sheet turning roller 33 is driven by a second drive section (not illustrated) via the shaft section 33a and rotates about a central axis along the Y-axis. The second drive section is, for example, an electric motor. The second drive section changes the rotation and stop, the rotation direction, the rotation speed, and the rotation time of the sheet turning roller 33 under the control of the control section 10. When the sheet turning section 30 performs the sheet turning process, the sheet turning roller 33 rotates clockwise when viewed from the -Y direction. In processes other than the sheet turning process, the control section 10 appropriately changes the rotation direction of the sheet turning roller 33.

The biasing section 37 biases the sheet turning roller 33 in the -Z direction toward the support surface 31a of the support section 31 via the holding member 35 and the shaft section 33a. The biasing section 37 is also arranged at an end section of the shaft section 33a in the -Y direction. The biasing section 37 is, for example, a coil spring. The biasing section 37 in the +Y direction and the biasing section 37 in the -Y direction are each provided with the adjustment unit 60. In FIG. 3, only the biasing section 37 and the adjustment unit 60 in the +Y direction are illustrated.

The adjustment unit 60 adjusts a pressing force of the sheet turning roller 33 against the medium B and a position of the sheet turning roller 33 in the up-down direction. The adjustment unit 60 is arranged above the biasing section 37 and contacts the biasing section 37 from above. A pressing force may be adjusted depending on the physical properties of the sheet S, such as the thickness and stiffness. For example, in a case of a thin sheet S, it is desirable to weaken a pressing force from the viewpoint of preventing overlapping in the sheet turning process. A user may select the magnitude of a pressing force on the operation panel 5.

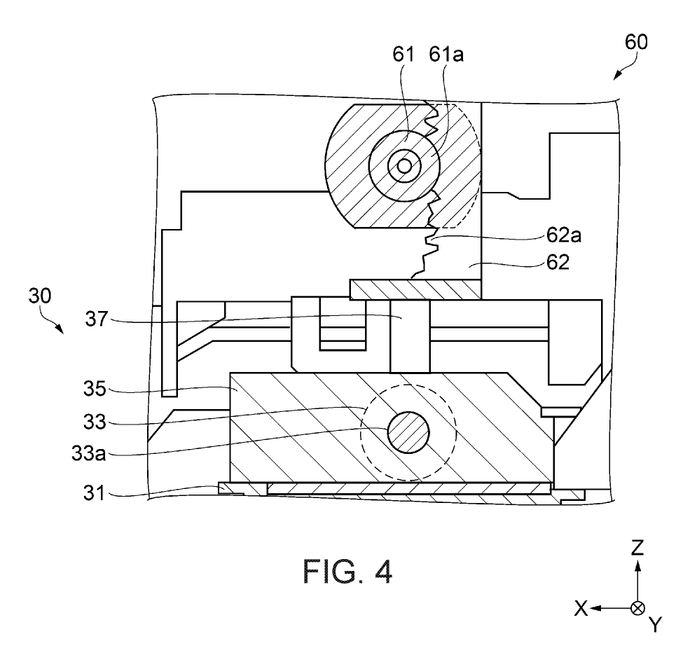

As illustrated in FIG. 4, the adjustment unit 60 includes a drive motor 61 including a pinion section 61a and a pressing member 62 including a rack section 62a. The drive motor 61 is fixed to a structural member (not illustrated) of the image reading device 1. The drive motor 61 is controlled by the control section 10 to rotate forward and backward.

The pinion section 61a is directly connected to a rotation shaft of the drive motor 61. The rack section 62a is arranged in the -X direction of the pinion section 61a so as to mesh with the pinion section 61a. A plurality of teeth of the rack section 62a are provided along the up-down direction. The pressing member 62 contacts an upper end of the biasing section 37 at a bottom surface facing downward.

When a pressing force and an up-down position of the sheet turning roller 33 are adjusted, the above-described control section 10 rotationally drives the drive motor 61. The rotation of the drive motor 61 is transmitted to the rack section 62a via the pinion section 61a, and displaces the pressing member 62 in the up-down direction. A position of an upper end of the biasing section 37 is changed by the displacement of the pressing member 62, and a force pressing the biasing section 37 downward is changed. A pressing force increases as the pressing member 62 is displaced downward, and the pressing force decreases as the pressing member 62 is displaced upward. By this, the magnitude of a pressing force of the sheet turning roller 33 with respect to the medium B is changed.

The adjustment unit 60 is not limited to the above-described configuration, and may include a configuration in which a cam is attached to the drive motor 61, or a configuration using an electric actuator or the like.

Referring back to FIG. 2, a detection section 40 is arranged above the transport path R. The detection section 40 detects overlapping of the sheets S turned by the sheet turning roller 33. The detection section 40 prevents the sheet S from being skipped and read, and thus the convenience is further improved. The detection section 40 is an ultrasonic sensor, and includes an emit section 41 and a receive section 42. The emit section 41 emits ultrasonic waves toward the receive section 42, and the receive section 42 receives the emitted ultrasonic waves.

The emit section 41 and the receive section 42 face each other in a direction along the X-axis. The emit section 41 is arranged in the +X direction with respect to the sheet turning roller 33, and the receive section 42 is arranged in the -X direction. When the sheet turning roller 33 turns the sheet S, the turned sheet S passes between the emit section 41 and the receive section 42.

The strength of ultrasonic waves received by the receive section 42 is transmitted to the control section 10. When the sheet S is turned in an overlapping manner, ultrasonic waves received by the receive section 42 are weakened as compared with a case where the number of the sheets S is one. The control section 10 determines whether the sheet S is turned in an overlapping manner based on an attenuation state of ultrasonic waves received by the receive section 42 with respect to ultrasonic waves emitted from the emit section 41. The detection section 40 is not limited to an ultrasonic type, and may be, for example, an optical sensor or the like.

The transport rollers 23a, 23b, 23c, and 23d transport the medium B in the -X direction or the +X direction and move a position of the sheet S to be read by the reading section 50. The rear roller 25 assists the transport of the transport rollers 23c and 23d, and transports the medium B from the reading section 50 in the -X direction or from the turning point in the +X direction.

The transport rollers 23a, 23b, 23c, 23d, and the rear roller 25 are substantially cylindrical rotation members, and a shaft section (not illustrated) penetrates the center of each of the transport rollers 23a, 23b, 23c, 23d, and the rear roller 25. Each shaft section is a substantially rod-shaped member and is arranged along the Y-axis. Two of each of the transport rollers 23a, 23b, 23c, 23d, and the rear rollers 25 are provided in a direction along the Y-axis. The number of each of the transport rollers 23a, 23b, 23c, 23d, and the rear rollers 25 is not limited to two, and may be one or three or more.

The transport rollers 23a and 23b are paired in the up-down direction, and the transport rollers 23c and 23d are also paired in the up-down direction. The transport rollers 23a and 23b are arranged in the +X direction with respect to the reading section 50, and the transport rollers 23c and 23d are arranged in the -X direction. The transport rollers 23a and 23c are arranged above the transport path R, and the transport rollers 23b and 23d are arranged below the transport path R. The rear roller 25 is arranged above the transport path R in the -X direction of the transport roller 23c.

The transport rollers 23a, 23b, 23c, and 23d and the rear roller 25 are formed of elastic materials such as rubber.

The transport rollers 23a, 23b, 23c, and 23d and the rear roller 25 are driven by a third drive section (not illustrated) via the corresponding shaft sections and rotate about central axes along the Y-axis. The medium B is transported while being sandwiched between the transport roller 23a and the transport roller 23b and between the transport roller 23c and the transport roller 23d. When the medium B is transported in the -X direction, the transport rollers 23a and 23c and the rear roller 25 rotate counterclockwise, and the transport rollers 23b and 23d rotate clockwise. When the medium B is transported in the +X direction, the transport rollers 23a, 23b, 23c, and 23d and the rear roller 25 rotate in directions opposite to those described above.

The third drive section is, for example, an electric motor. The third drive section changes the rotation and stop, the rotation direction, the rotation speed, and the rotation time in the transport rollers 23a, 23b, 23c, and 23d and the rear roller 25 under the control of the control section 10. The operations of the third drive section, the first drive section, and the second drive section are individually controlled by the control section 10.

The transport roller 23a is supported by a support member (not illustrated) via the corresponding shaft section, is biased downward, and is displaced in the up-down direction. The distance between the transport roller 23a and the transport roller 23b is adjusted depending on the thickness of the medium B in the up-down direction. By this, the distance is adjusted depending on the thickness of the medium B, and the medium B is sandwiched between the transport rollers 23a and 23b.

The transport roller 23c is also supported by a support member (not illustrated) via the corresponding shaft section, is biased downward, and is displaced in the up-down direction. The distance between the transport roller 23c and the transport roller 23d is adjusted depending on the thickness of the medium B in the up-down direction. By this, the distance is adjusted depending on the thickness of the medium B, and the medium B is sandwiched between the transport rollers 23c and 23d.

The reading section 50 reads an image or the like formed on the sheet S and transmits read image information to the control section 10. The reading section 50 is on the transport path R, and is provided downstream of the sheet turning section 30 in the transport direction of the forward path, in other words, in the -X direction of the sheet turning section 30.

The reading section 50 includes an upper unit 51 and a lower unit 52. The upper unit 51 and the lower unit 52 face each other in the up-down direction with the transport path R interposed therebetween. The upper unit 51 is arranged above the transport path R, and the lower unit 52 is arranged below the transport path R. The upper unit 51 reads the sheets S of two pages facing upward in the opened medium B. The lower unit 52 reads the front cover and the back cover of the medium B. When reading of the front cover and the back cover is not necessary, the lower unit 52 may be omitted.

Although not illustrated, in each of the upper unit 51 and the lower unit 52, a plurality of solid-state imaging elements are arranged linearly along the Y-axis. A document reading surface of the upper unit 51 and a document reading surface of the lower unit 52 are parallel to the transport path R.

Since the image reading device 1 employs the solid-state imaging element, the device can be easily downsized as compared with a configuration using, for example, an image pickup tube. This increases the degree of freedom of an installation location of the image reading device 1, and further improves the convenience. In a direction along the Y-axis, the distance at which the plurality of solid-state imaging elements are arranged is equal to or larger than the dimension of the medium B applicable to the image reading device 1.

Examples of the solid-state imaging element include a charge coupled device (CCD) image sensor and a complementary metal oxide semiconductor (CMOS) image sensor. The image reading device 1 uses a contact image sensor (CIS) module.

Although not illustrated, the upper unit 51 and the lower unit 52 each include a back plate. Specifically, the upper unit 51 is provided with the back plate at a position facing the plurality of solid-state imaging elements of the lower unit 52 in the up-down direction. The lower unit 52 is also provided with the back plate at a position facing the plurality of solid-state imaging elements of the upper unit 51 in the up-down direction. The back plate is a reference plate read by the facing solid-state imaging element for shading correction. As the back plate, for example, a resin plate or a metal plate colored in white, gray, black, or the like is adopted. In the image reading device 1, a white resin plate is used.

The back plate of the upper unit 51 and the back plate of the lower unit 52 are driven by motors (not illustrated) to change between a facing state in which the back plates face the corresponding solid-state imaging elements and a non-facing state in which the back plates do not face the corresponding solid-state imaging elements. Since the reference plate is white, a white reference value is acquired in the facing state, and a black reference value is acquired in the non-facing state.

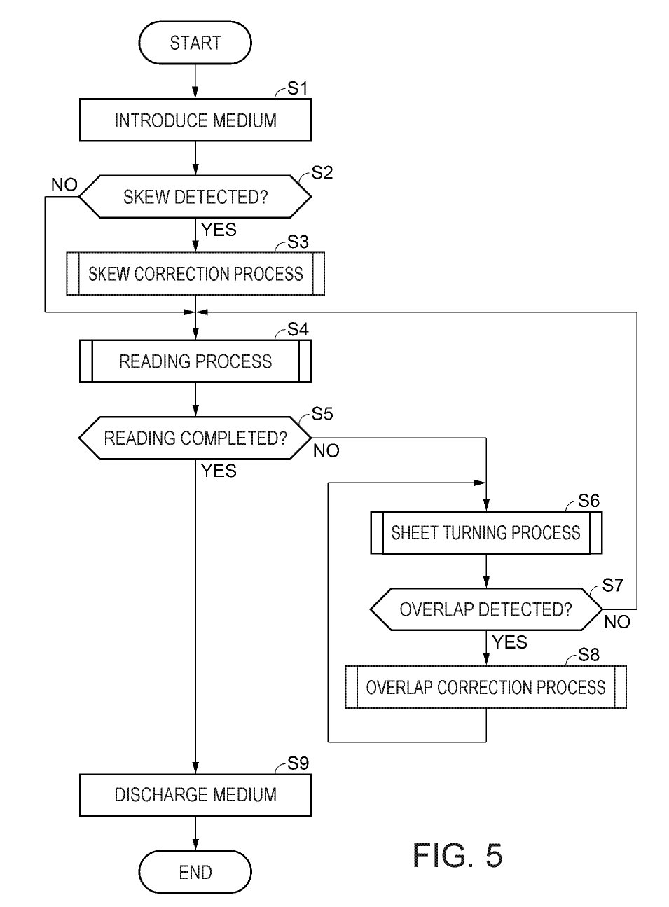

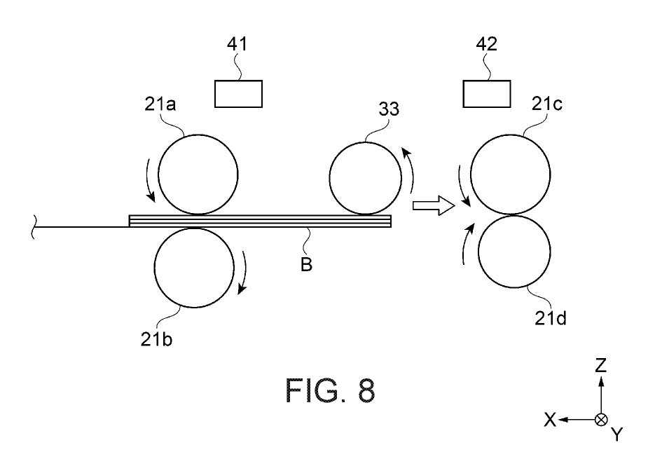

An image reading method including the sheet turning process of the image reading device 1 will be described. As illustrated in FIG. 5, the reading method has a step S1 to a step S9. The reading method described below is an example, and the reading method is not limited thereto. In the following description, FIGS. 1 and 2 described above are also referred to, although not particularly specified. In the description of FIGS. 8 to 18 referred to below, the rotation direction of each roller is described as viewed from the -Y direction.

In the step S1, the medium B is introduced into the image reading device 1. A user opens the sheet S of the medium B to be read and places the sheet S on the placement section 9 with the front cover and the back cover facing downward. At this time, the user aligns the boundary between adjacent sheets S along the Y-axis and inserts a part of the medium B into the feed port 7. Next, the user instructs the start of reading on the operation panel 5. By this, reading is started. Then, the step proceeds to a step S2.

In the step S2, the presence or absence of skew of the medium B with respect to the X-axis is detected. When skew is not detected, the step proceeds to a reading operation of a step S4, and when skew is detected, the step proceeds to correction of the skew of a step S3.

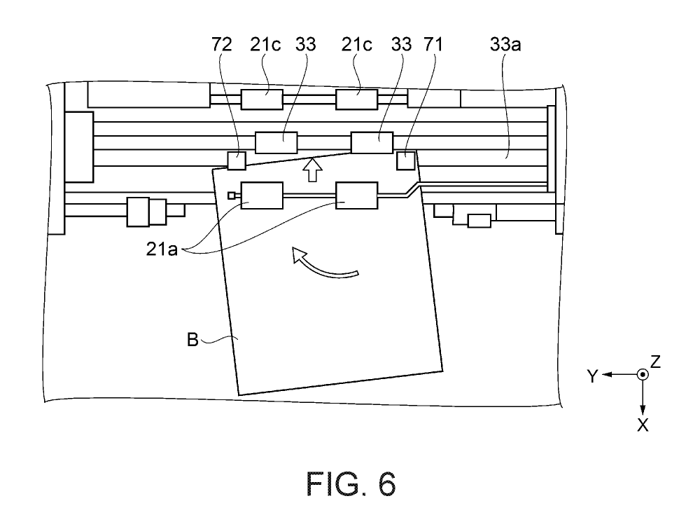

As illustrated in FIG. 6, skew detection sections 71 and 72 is provided above the above-described transport path R and between the sheet turning roller 33 and the transport roller 21a. The skew detection sections 71 and 72 are arranged along the Y-axis so as to be spaced apart from each other. The skew detection sections 71 and 72 are non-contact type optical sensors such as photosensors. The skew detection sections 71 and 72 each detect the presence or absence of the medium B on the transport path R. Detection results of the skew detection sections 71 and 72 are transmitted to the control section 10.

When the medium B is skewed with respect to the X-axis, a deviation occurs in the timing at which the skew detection sections 71 and 72 detect the medium B. The control section 10 determines whether or not the medium B is skewed from the deviation.

In the step S3, a skew correction process of the medium B is performed. The control section 10 causes the transport rollers 21a and the transport rollers 21b (not illustrated) of the transport section 20 to transport the medium B in the -X direction in a state where the rotation of the sheet turning rollers 33 is stopped. At this time, a region in the -Y direction of an edge in the -X direction of the medium B abuts against the sheet turning roller 33 and cannot move. On the other hand, a region in the +Y direction of an edge in the -X direction of the medium B is separated from the sheet turning roller 33, and thus moves substantially in the +X direction. By this, the medium B rotates substantially clockwise when viewed from above.

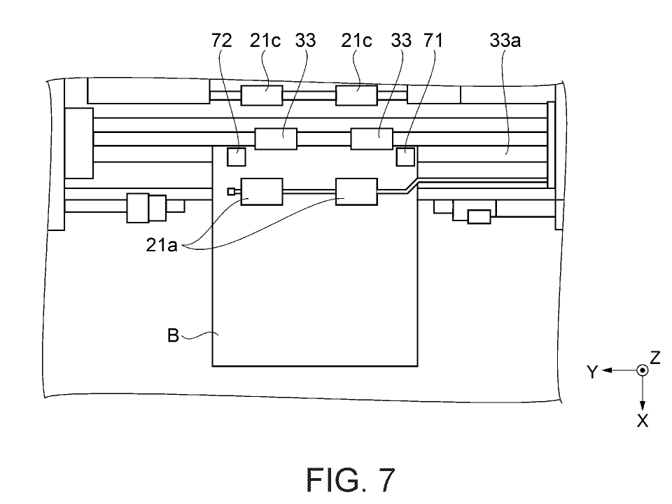

When the rotation of the medium B proceeds, skew is corrected as illustrated in FIG. 7, and a short side of the medium B on a leading edge side in the -X direction is along the shaft section 33a that is a rotation shaft of the sheet turning rollers 33. After skew is corrected and the above-described state is achieved, the control section 10 rotates the sheet turning rollers 33 and the transport section 20 to resume the transport of the medium B in the -X direction. Note that, even when the medium B is skewed in a direction opposite to the above-described direction, the skew is corrected in the same manner. Since skew of the medium B is corrected, the quality of an image that is read can be improved.

The completion of skew correction of the medium B may be detected by the skew detection sections 71 and 72, or may be determined by time management in which the sheet turning roller 33 is stopped and the transport section 20 is driven. The number of skew detection sections 71 and 72 is not limited to two, and may be three or more. In a case where a guide member or the like is provided to suppress the occurrence of skew, the steps S2 and S3, the skew detection sections 71 and 72, and the like may be omitted. Then, the step proceeds to the step S4.

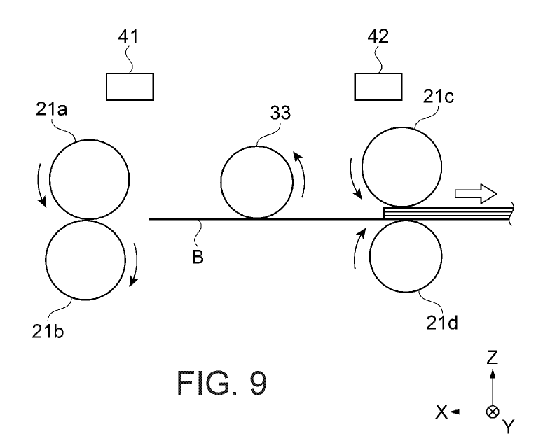

In the step S4, the reading process of the sheet S is performed. Specifically, as illustrated in FIGS. 8 and 9, the transport rollers 21a and 21c and the sheet turning roller 33 are rotated counterclockwise, and the transport rollers 21b and 21d are rotated clockwise, thereby transporting the medium B in the -X direction. The medium B is transported to the reading section 50, and the sheet S is read. The reading process is performed in the forward path in order from the sheet S having the smallest page number on a -X direction side. Then, the step proceeds to a step S5.

Referring back to FIG. 5, in the step S5, it is determined whether the reading process is completed or continued. The control section 10 determines whether or not to complete the reading process from reading requirement input by a user in advance. When the reading process is continued, the process proceeds to the sheet turning process of a step S6. If the reading process is continued, the process proceeds to the sheet turning process of the step S6, and if the reading process is completed, the process proceeds to the discharge of the medium B of the step S9.

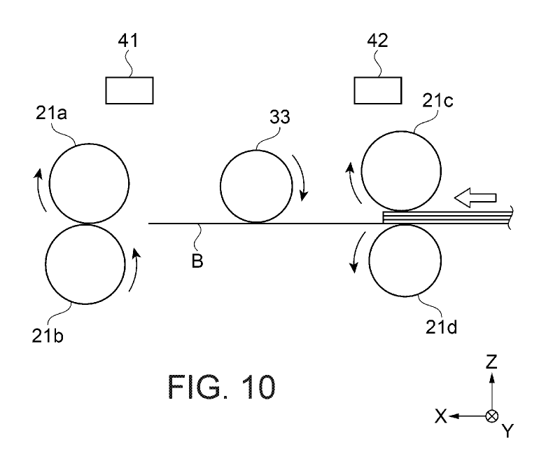

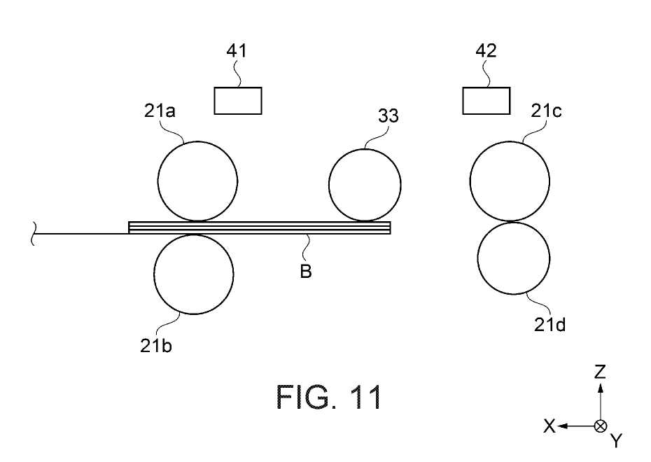

In the step S6, the sheet turning process of the sheet S is performed. Specifically, as illustrated in FIG. 10, the transport rollers 21a and 21c and the sheet turning roller 33 are rotated clockwise, and the transport rollers 21b and 21d are rotated counterclockwise, thereby pulling back the medium B from the reading section 50 in the +X direction. Then, as illustrated in FIG. 11, when the vicinity of an end section of the medium B in the -X direction reaches a position where the end section contacts the sheet turning roller 33, the transport of the medium B is completely stopped.

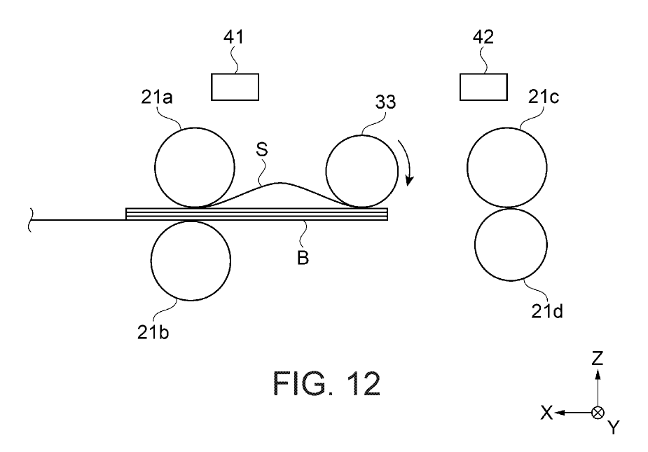

Next, as illustrated in FIG. 12, the sheet turning roller 33 is rotated clockwise while the transport rollers 21a, 21b, 21c, and 21d are stopped. Here, at the start of turning the sheet S by rotating the sheet turning roller 33, a pressing force of the sheet turning roller 33 against the medium B is set to a first pressing force. A pressing force after the start of turning the sheet S is set to a second pressing force.

The second pressing force is desirably changed to a force weaker than the first pressing force. After the sheet S is started to be turned with the first pressing force at the start of the sheet turning process, the pressing force is switched to the second pressing force during the sheet turning process, thereby suppressing the sheet S from being turned in an overlapping manner. This further improves the convenience of a user.

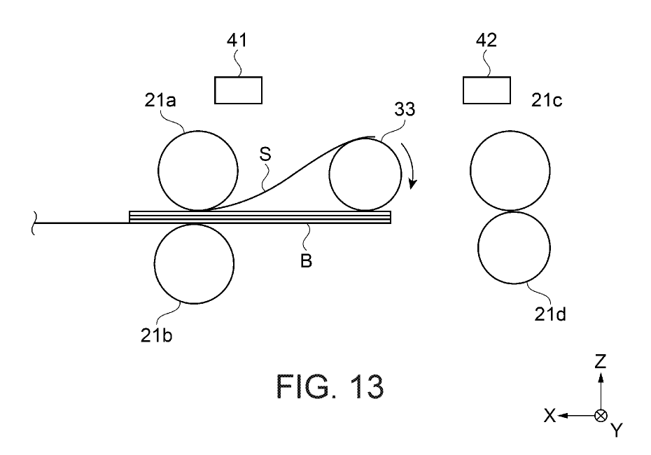

When the sheet turning roller 33 rotates clockwise, the uppermost sheet S that contacts the sheet turning roller 33 is turned upward. When this operation is further continued, as illustrated in FIG. 13, a leading edge of the turned sheet S in the -X direction climbs over the sheet turning roller 33 and rides on the sheet turning roller 33. Next, from a state illustrated in FIG. 13, the sheet turning roller 33 and the transport rollers 21a and 21c are rotated counterclockwise, and the transport rollers 21b and 21d are rotated clockwise. By this, the medium B moves in the -X direction in a state where the sheet S rides on the sheet turning roller 33. Then, the step proceeds to a step S7.

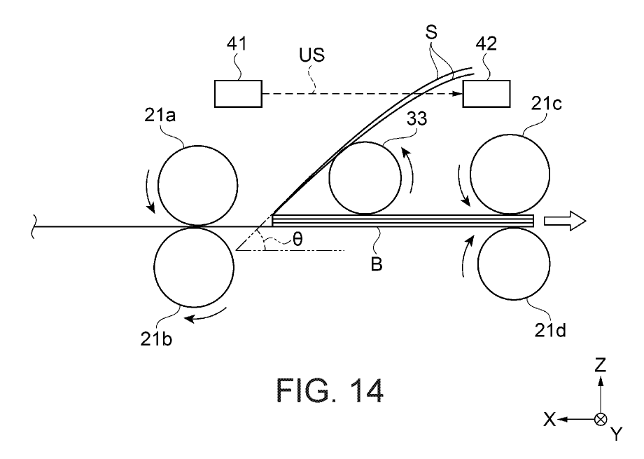

Referring back to FIG. 5, in the step S7, it is determined whether or not the detection section 40 detects overlapping of the turned sheets S. Specifically, as illustrated in FIG. 14, when two or more sheets S are turned in an overlapping manner, a plurality of the sheets S are interposed on a path of ultrasonic waves US between the emit section 41 and the receive section 42. The intensity of the ultrasonic waves US received by the receive section 42 is transmitted to the control section 10. The control section 10 compares the intensity of the ultrasonic waves US emitted by the emit section 41 with the intensity of the ultrasonic waves US received by the receive section 42 to determine whether or not the sheet S is overlapped.

The detection section 40 detects the overlap of the sheets S in a state where an angle θ formed between the transport direction and the turned sheet S that sandwiches the sheet turning roller 33 between itself and the transport direction, is an acute angle when viewed from the -Y direction. The -Y direction is a direction orthogonal to the transport direction of the medium B and the -Z direction that is the vertical direction. By this, the medium B moves further in the -X direction, and the overlap of the sheets S is detected before the angle θ becomes a right angle or an obtuse angle. Therefore, unnecessary movement of the medium B can be suppressed, and time can be saved. The control section 10 stops the movement of the sheet S and the rotation of the sheet turning roller 33 at the time of receiving a detection result of the receive section 42.

Referring back to FIG. 5, when the overlap of the sheets S is detected, the step proceeds from the step S7 to a step S8. When no overlap is detected in the sheets S, the step proceeds from the step S7 to the step S4.

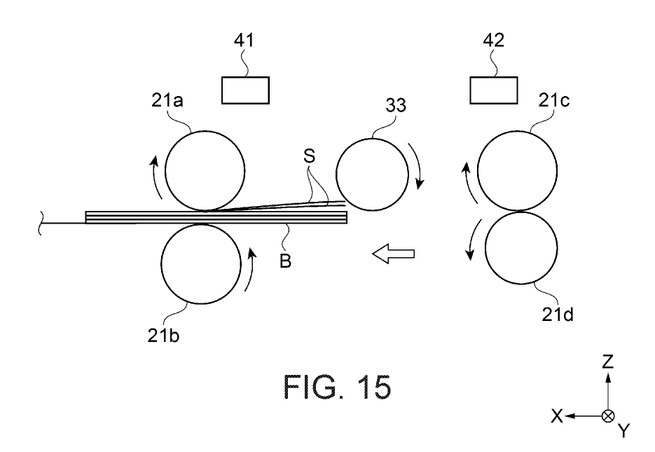

In the step S8, a process of correcting the overlap of the sheets S is performed. Specifically, as illustrated in FIG. 15, when the detection section 40 detects the overlap of the sheets S, the control section 10 transports the medium B in the +X direction upstream of the sheet turning roller 33 of the sheet turning section 30. Then, the turned sheets S are integrated with the unturned sheets S, and are returned to a state before the sheets S are turned. Next, the movement of the medium B in the +X direction is stopped. At this time, an end section of the medium B in the -X direction may be returned until passing between the transport rollers 21a and 21b, and the curl of the sheets S due to the turning may be alleviated.

Thereafter, the medium B is transported again in the -X direction toward the sheet turning roller 33 of the sheet turning section 30. When the sheets S are turned in an overlapping manner, the turned sheets S are returned and the sheet turning process is performed again. Since these operations are automatically performed, it is possible to prevent the reading of the sheet S from being missed, and the convenience of a user is further improved. Then, at the time when a leading edge of the medium B in the -X direction reaches a start position of the sheet turning process illustrated in FIG. 11, the step returns to the step S6 and the sheet turning process is performed again.

When the medium B is transported again toward the sheet turning roller 33 of the sheet turning section 30 to turn the sheet S again, the control section 10 adjusts a pressing force of the sheet turning roller 33 against the medium B depending on the thickness of the medium B in the up-down direction. Specifically, when the thickness of the medium B is relatively large, the pressing force is adjusted to be reduced. This suppresses the occurrence of the overlap again.

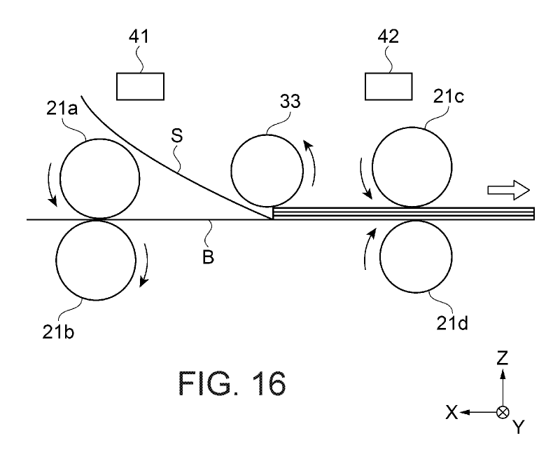

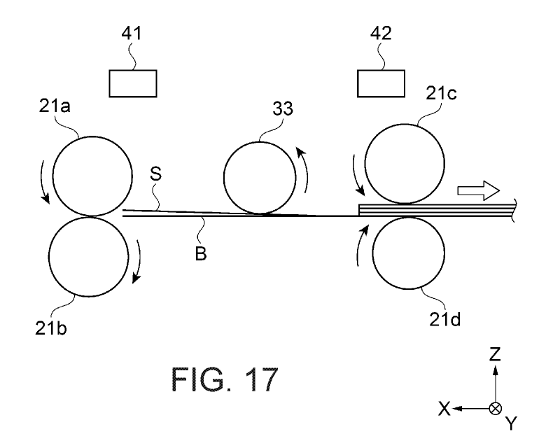

Referring back to FIG. 5, when the overlap of the sheets S is not detected in the step S7, the step S4 is performed. At this time, as illustrated in FIGS. 16 and 17, the transport rollers 21a and 21c and the sheet turning roller 33 are rotated counterclockwise, and the transport rollers 21b and 21d are rotated clockwise, thereby transporting the medium B in the -X direction. As the medium B is transported in the -X direction, the turned sheet S is turned to an opposite side from its original position and closed.

Thereafter, the step S4 and then the step S5 are performed. The above steps are repeated until the reading of the medium B is completed. When the reading is completed, the step proceeds to the step S9.

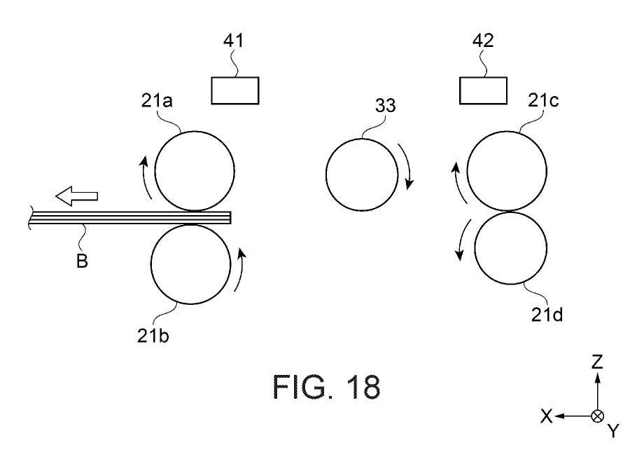

Referring back to FIG. 5, in the step S9, the medium B for which reading has been completed is discharged to the outside of the housing 3. Specifically, as illustrated in FIG. 18, the medium B is transported in the +X direction by rotating the transport rollers 21a and 21c and the sheet turning roller 33 clockwise and rotating the transport rollers 21b and 21d counterclockwise. By this, the medium B is discharged from the feed port 7 and is placed on the placement section 9, and a series of reading steps is completed.

According to the present embodiment, the following effects can be obtained.

The reading section 50 can read the sheet S while the sheet turning section 30 turns the sheet S. This can improve the convenience of a user.

What is claimed is:

1. An image reading device comprising:
a transport section that transports, along a transport path, a medium in which plural sheets are bound together;
a sheet turning section that is provided on the transport path and that turns the sheets of the medium being transported; and
a reading section that is provided on the transport path and downstream of the sheet turning section in a transport direction, and that reads the sheets.

2. The image reading device according to claim 1, wherein
the reading section includes a solid-state imaging element.

3. The image reading device according to claim 1, wherein
the sheet turning section includes
a support section including a support surface that supports the medium,
a sheet turning roller that is arranged to face the support section, and
a biasing section that biases the sheet turning roller toward the support section and
a distance between the sheet turning roller and the support section is changed depending on a thickness of the medium.

4. The image reading device according to claim 3, further comprising:
a detection section that detects overlapping of the sheets turned by the sheet turning roller.

5. The image reading device according to claim 4, wherein
the detection section detects overlapping in a state where an angle formed between the transport direction and the turned sheet that sandwiches the sheet turning roller between itself and the transport direction, is an acute angle when viewed from a direction orthogonal to the transport direction and to a vertical direction.

6. The image reading device according to claim 5, wherein
when the detection section detects overlapping, the medium is transported upstream of the sheet turning section in the transport direction, the turned sheet is returned to a state before being turned, and then the medium is transported again toward the sheet turning section.

7. The image reading device according to claim 6, further comprising:
an adjustment unit that adjusts a pressing force of the sheet turning roller against the medium depending on the thickness of the medium when the medium is transported again toward the sheet turning section and the sheet is turned again.

8. The image reading device according to claim 7, wherein
at a start of turning the sheet by rotating the sheet turning roller, the pressing force of the sheet turning roller against the medium is a first pressing force and
the pressing force after the start of the turning the sheet changes to a second pressing force weaker than the first pressing force.

9. The image reading device according to claim 3, wherein
the medium is transported by the transport section in a state where the sheet turning roller is stopped, and the sheet turning roller is rotated after a short side of the medium on a leading edge side is aligned with a rotation shaft of the sheet turning roller.

10. The image reading device according to claim 1, further comprising:
a housing and
a feed port provided in the housing, wherein
the medium
is fed into the housing from the feed port,
returned after an image is read in the housing, and discharged to an outside of the housing from the feed port.
